(19) United States
(12) Patent Application Publication
(10) Pub. No.: US 2026/0030342 A1
(43) Pub. Date: Jan. 29, 2026

(54) Trusted Port Based Communication Queues for Secure Runtime Device Specific Execution

(71) Applicant: Dell Products L.P., Round Rock, TX (US)

(72) Inventors: Sagar Alatgi, Bangalore (IN); Gowrishankar Rudraprakash, Bengaluru (IN); Shekar Babu Suryanarayana, Bangalore (IN)

(21) Appl. No.: 18/783,970

(22) Filed: Jul. 25, 2024

(51) Int. Cl. G06F 21/53; G06F 21/44; G06F 21/57

(52) U.S. Cl. CPC G06F 21/53; G06F 21/44; G06F 21/572

(57) ABSTRACT

A firmware management operation. The firmware management operation includes providing an information handling system with a distributed BIOS; identifying device specific data associated with a device of the information handling system; enumerating a trusted port via a trusted queue management operation; and, authorizing device specific communication via the trusted port, the device specific communication using a device-specific buffer handling operation.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed BIOS; identifying device specific data associated with a device of the information handling system; enumerating a trusted port via a trusted queue management operation; and, authorizing device specific communication via the trusted port, the device specific communication using a device-specific buffer handling operation.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying device specific data associated with a device of the information handling system; enumerating a trusted port via a trusted queue management operation; and, authorizing device specific communication via the trusted port, the device specific communication using a device-specific buffer handling operation.

In another embodiment the invention relates to a computer-readable storage medium embodying computer program code, the computer program code comprising computer executable instructions configured for: providing an information handling system with a distributed BIOS; identifying device specific data associated with a device of the information handling system; enumerating a trusted port via a trusted queue management operation; and, authorizing device specific communication via the trusted port, the device specific communication using a device-specific buffer handling operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram showing certain security vulnerabilities associated with unprotected work queues used in the operation of an information handling system (IHS);

FIGS. 6a and 6b are a simplified block diagram showing the performance of certain TQM operations; and

FIGS. 7a and 7b are a simplified sequence diagram showing the performance of certain TQM operations.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that Device-Specific Methods (DSM), familiar to skilled practitioners of the art, may be used to standardize certain IHS configurations across different operating systems. In particular, the use of DSM may ensure consistent variable formatting for inclusion in the Advanced Configuration and Power Interface (ACPI) namespace, allowing Original Design Manufacturers (ODMs) to tailor platform-specific features via an IHS's Basic Input/Output System (BIOS). Likewise, various aspects of the invention reflect an appreciation that Windows Management Instrumentation (WMI), operating system (OS), and Desktop and mobile Architecture for System Hardware (DASH) runtime services enable local and remote administration of an IHS. Various aspects of the invention likewise reflect an appreciation that these services are often considered integral to monitoring performance and gathering telemetry data. However, various aspects of the invention likewise reflect an appreciation that the effectiveness of security mechanisms that depend upon such telemetry to identify suspicious behavior, or to synthesize signals from endpoints, can be compromised if runtime services have exploitable flaws.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

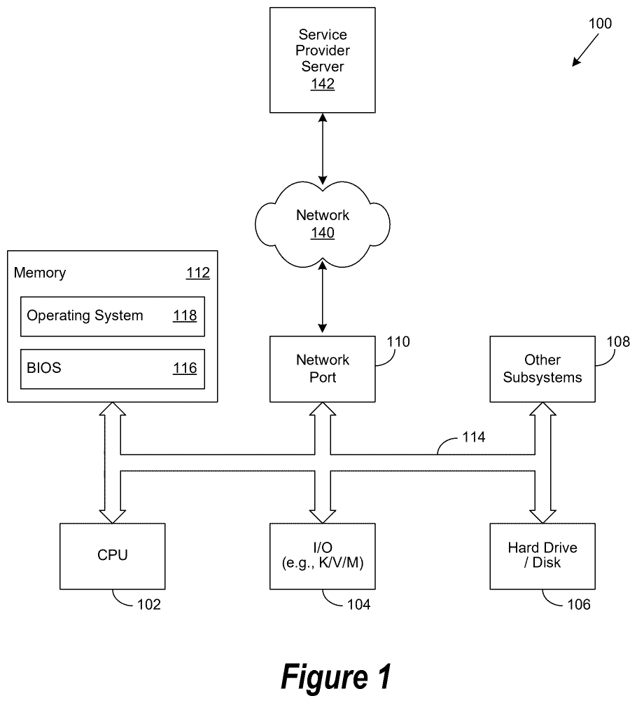

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100.

In various embodiments, the firmware management operation may be implemented to include the performance of a trusted queue management (TQM) operation. A TQM operation, as used herein, broadly refers to any function, task, procedure, or process performed, directly or indirectly, within a multi-processor operating environment, such as an architecture-specific distributed firmware management platform (ASDFMP), both of which are described in greater detail herein, to generate and manage trusted event queues, or work queues, or a combination thereof, to protect them from a malicious attack. In various embodiments, one or more TQM operations may be performed to receive a firmware component, verify its authenticity, allocate a portion of a particular IHS's 100 lower main memory 112 (e.g., 1 MB to 1 GB) for storing the verified firmware component, store the verified firmware component in the allocated portion of the data center asset's lower main memory in a trusted work queue, or a trusted event queue, or a combination of the two, such that it can be used at runtime by an OS 118 associated with the IHS 100. In certain embodiments, the firmware management operation may be performed during operation of an IHS 100. In various embodiments, performance of the firmware management operation may result in the realization of improved operation of an IHS 100.

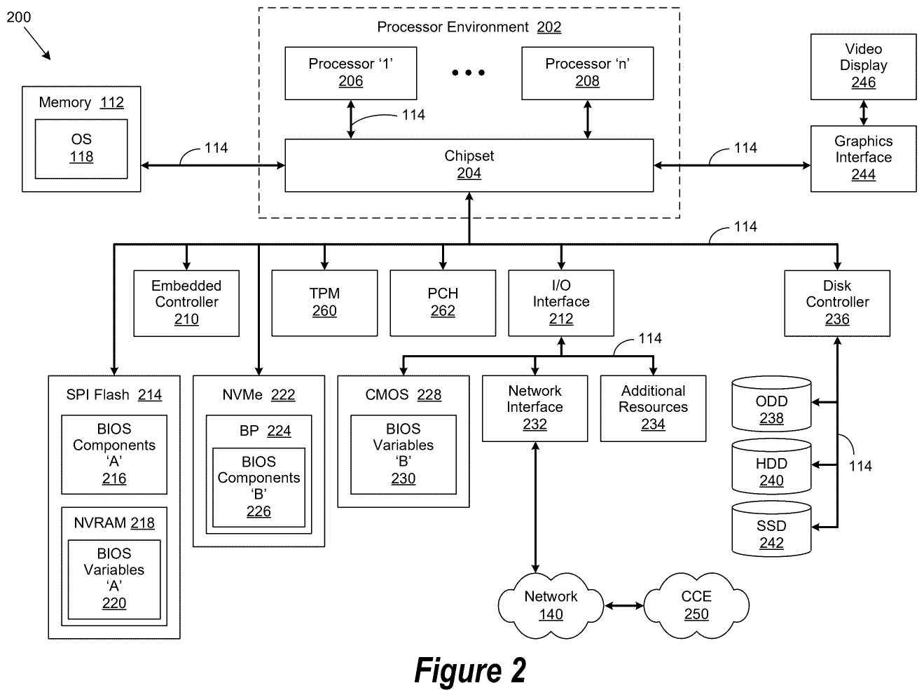

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

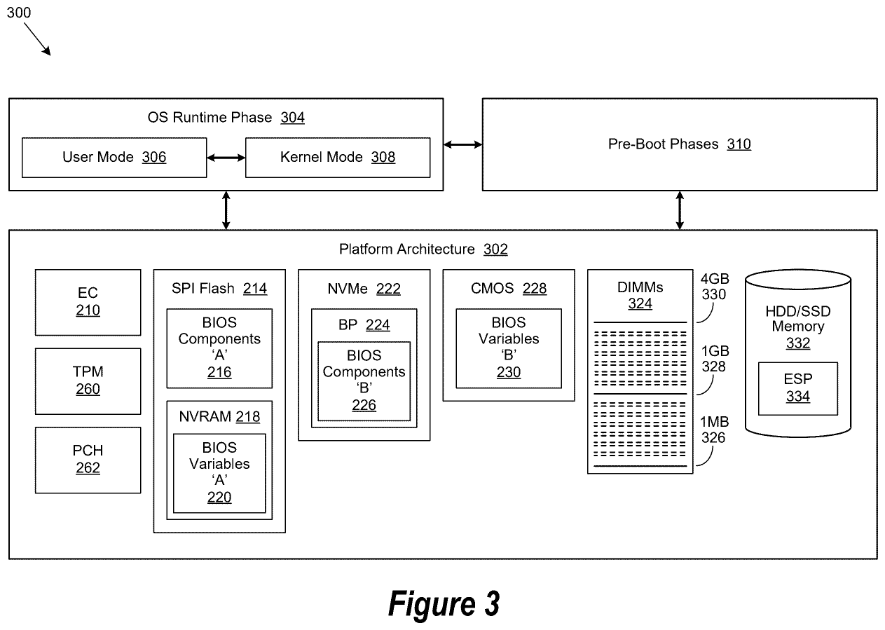

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

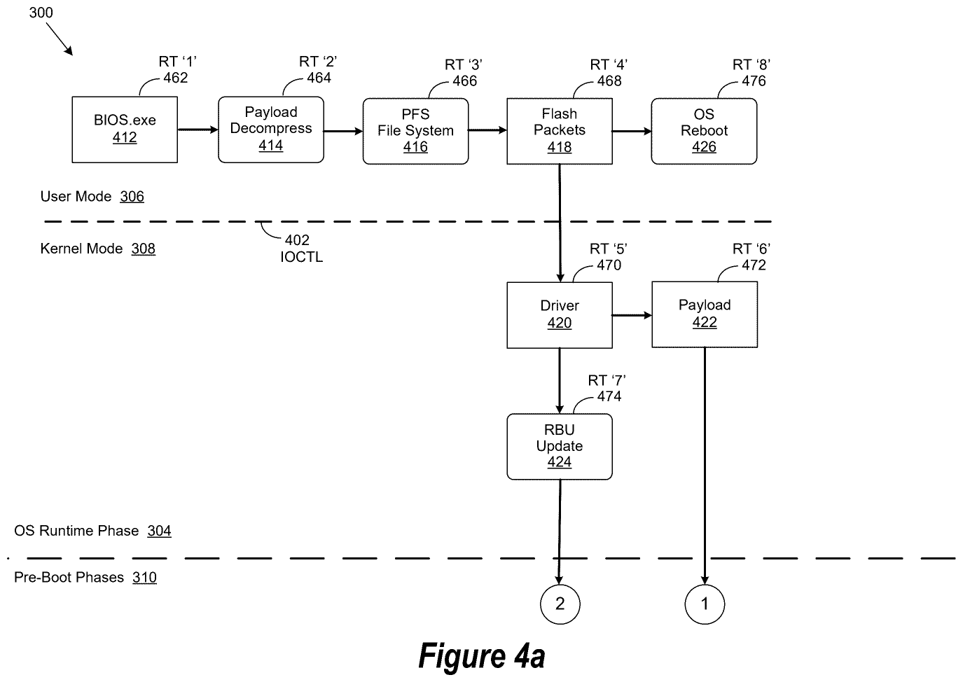

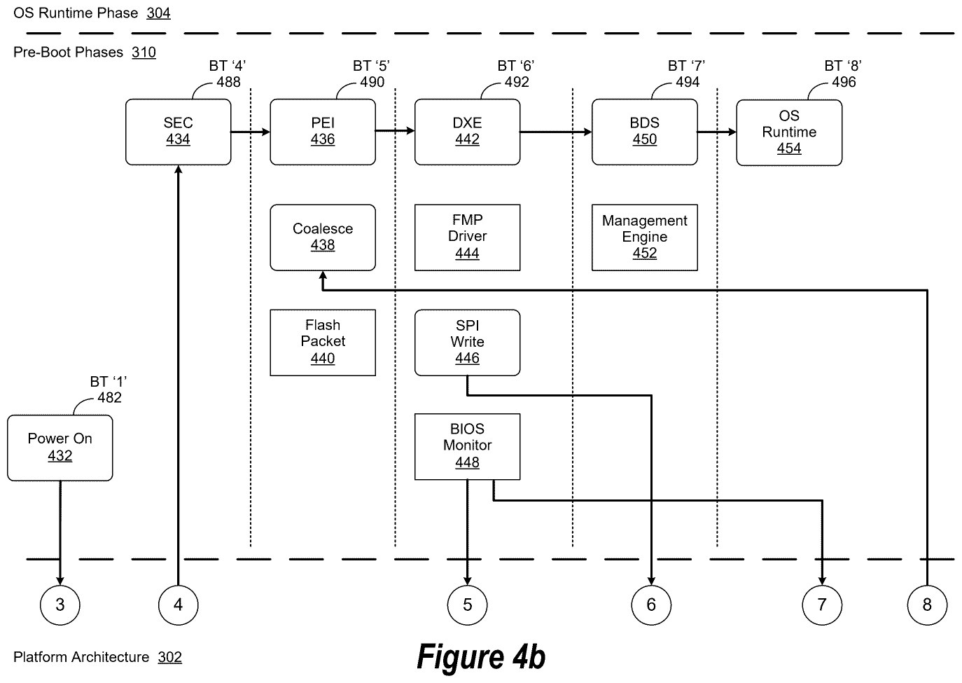

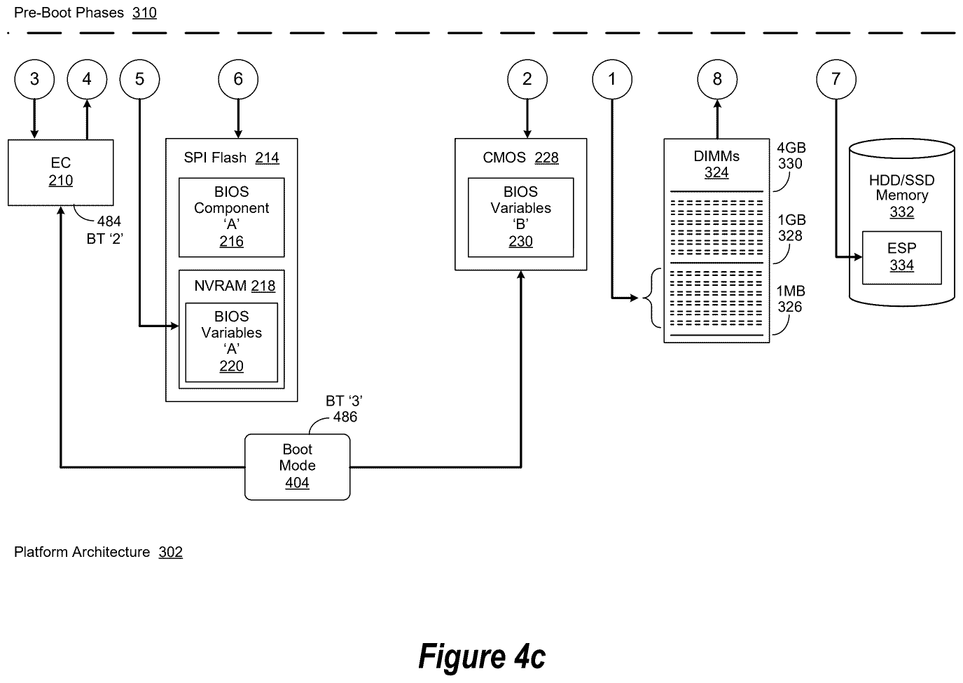

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one or more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

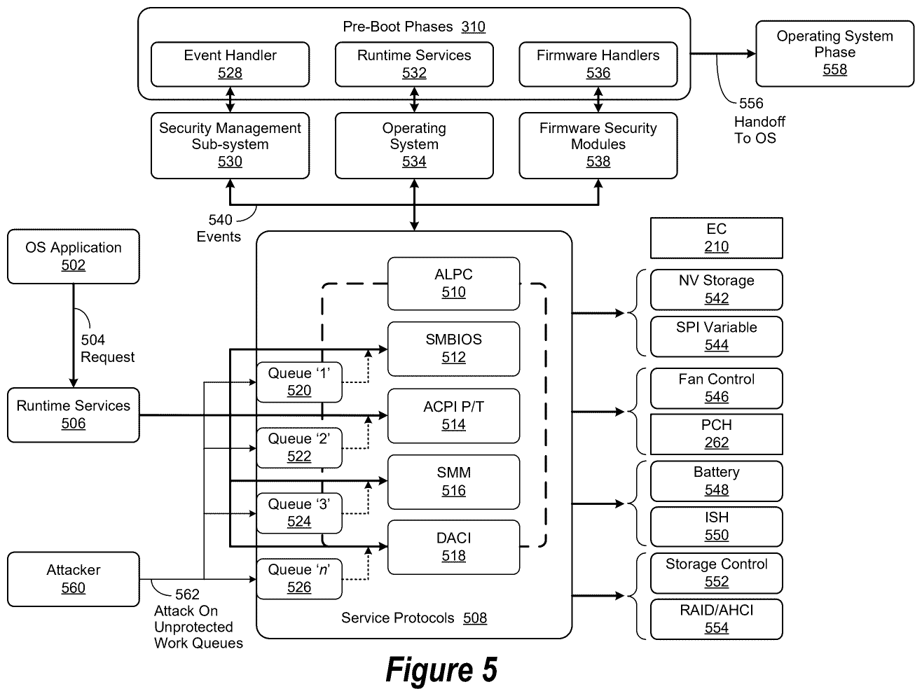

FIG. 5 is a simplified block diagram showing certain security vulnerabilities associated with unprotected work queues used in the operation of an information handling system (IHS) implemented in accordance with an embodiment of the invention. In various embodiments, an Operating System (OS) application 502 may place a service request 504 for a particular runtime service 502. In various embodiments, a request 504 for a particular runtime service 502 may be processed using an associated service protocol 508, such as System Management Basic Input/Output System (SMBIOS) 512, Advanced Configuration and Power Interface (ACPI) Power/Timing (P/T) 514, System Management Mode (SMM) 516, Advanced Communication Interface (ACI) 518, and so forth. In various embodiments, each request 504 for a particular runtime service 502 may be placed in an unprotected work queue ‘1’ 520. ‘2’ 522, ‘3’ 524 through ‘n’ 526 corresponding to the service protocol 508 used to service the request 504. In various embodiments, the queued requests 504 may be handled through the use of the Advanced Local Procedure Call (ALPC) 510 communication protocol, which in turn triggers corresponding events 540.

In various embodiments, such events 540 may be respectively handled by a security management sub-system 530, the OS 534 of the IHS, or one or more firmware security modules 538, or a combination thereof. In various embodiments, the security management sub-system 530, the OS 534 of the IHS, and the one or more firmware security modules 538 may respectively be implemented to interact with an event handler 528, certain runtime services 532, and one or more firmware handlers 536 during certain pre-boot phases 310, described in greater detail herein. In various embodiments, as likewise described in greater detail herein, the pre-boot phases 310 may be implemented to handoff 556 operation of the IHS to the OS phase 558.

In various embodiments, certain service protocols 508 may be implemented to interact with an embedded controller (EC) 210, non-volatile (NV) storage 542, one or more Serial Peripheral Interface (SPI) memory variables 544, or a fan control system 546, or a combination thereof. In various embodiments, certain service protocols 508 may likewise be implemented to interact with a battery control system 548, an integrated system hub (ISH) 550, a storage control system 552 or a Redundant Array of Independent Disks (RAID)/Advanced Host Controller Interface (ACHI) 554, or a combination thereof. In various embodiments, as described in greater detail herein, a malicious user, or attacker 560 may make an attack 562 on unprotected work queues ‘1’ 520. ‘2’ 522, ‘3’ 524 through ‘n’ 526.

Various embodiments of the invention reflect an appreciation that incoming device-specific OS runtime service 506 requests 504, such as Windows Management Instrumentation (WMI), directed towards Basic Input/Output System (BIOS) elements, such as SMBIOS 512), ACPI P/T 514, SMM 516, ACI 518, and so forth, are each respectively assigned to unprotected queues ‘1’ 520. ‘2’ 522, ‘3’ 524 through ‘n’ 526. As described in greater detail herein, these queued requests 504 are typically handled by the ALPC 510 communication protocol, which in turn triggers corresponding events 540. However, various embodiments of the invention reflect an appreciation that if an attacker 560 submits a malicious request, it will still be processed by the ALPC 510 protocol, potentially granting unauthorized access to the underlying IHS hardware, thus introducing a security vulnerability. Furthermore, various embodiments of the invention reflect an appreciation that a privileged user with access to bare metal OS 534, such as through a host Virtual Machine Manager (VMM) permission, may allow some SMM 516 memory to be overwritten, resulting in SMM 516 memory corruption that in turn may allow escalation of privilege. Likewise, various embodiments of the invention reflect an appreciation that microcode updates related to the implementation of device-specific methods during firmware transitions may corrupt data, especially when flushing buffers during the transition to System Transfer Mode (STM), thereby potentially affecting SMM 516 operation.

Various embodiments of the invention reflect an appreciation that a buffer overflow security vulnerability may occur in an IHS as a result of a buffer overflow occurring in their WMI Serial Memory Interconnect (SMI) handler. Likewise, various embodiments of the invention reflect an appreciation that in certain of these embodiments a locally authenticated malicious user could potentially exploit this vulnerability by sending malicious input to an SMI handler. Various embodiments of the invention likewise reflect an appreciation that under certain configurations, a privileged administrator user with access to bare metal OS, such as through a host Virtual Machine Manager (VMM) permission, may allow data corruption to occur when in SMM 516.

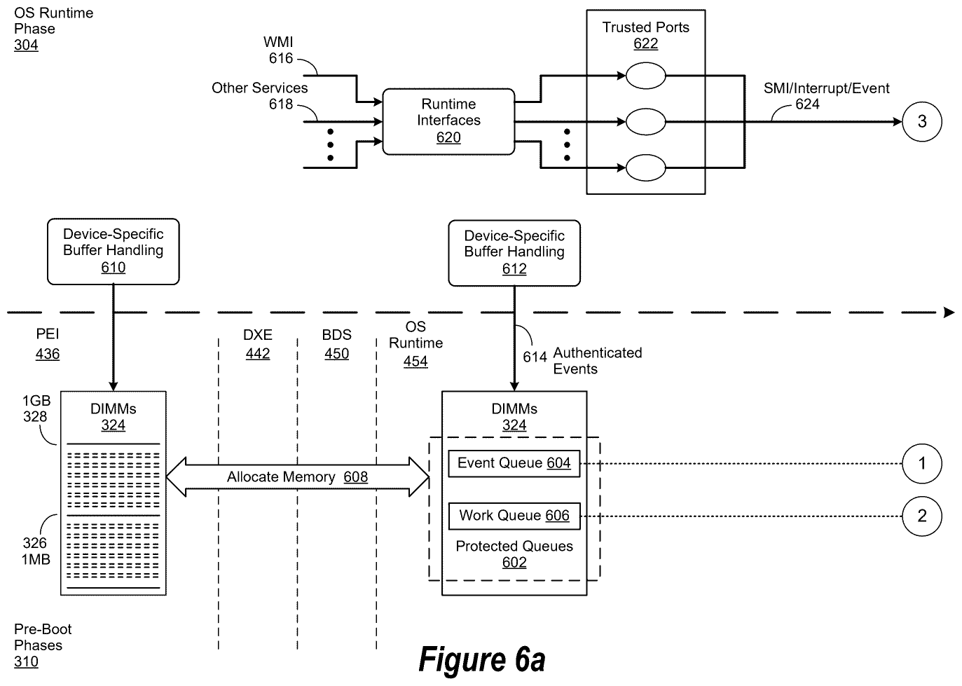

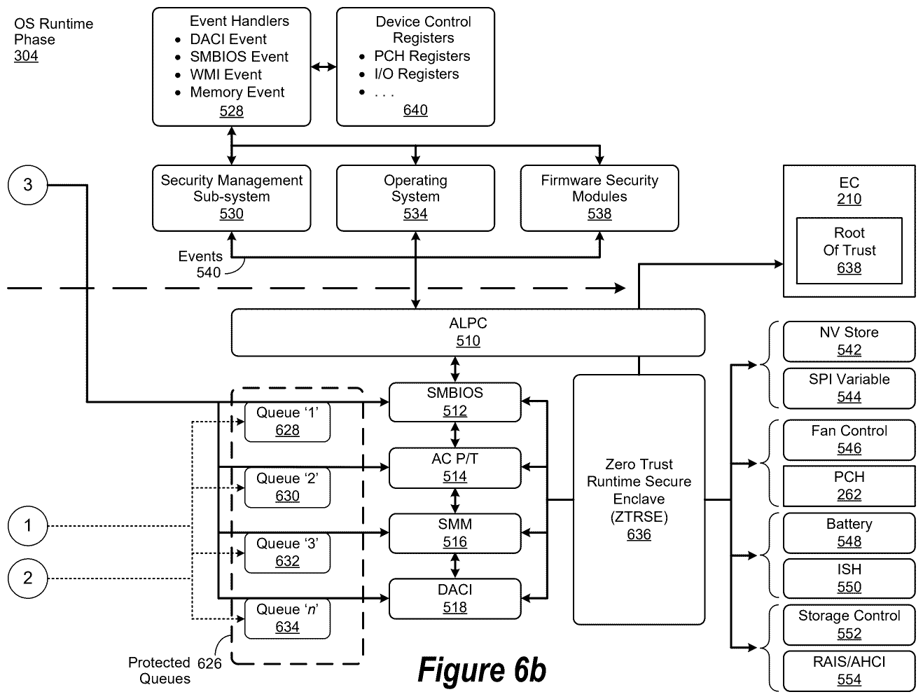

FIGS. 6a and 6b are a simplified block diagram showing the performance of certain trusted queue management (TQM) operations implemented in accordance with an embodiment of the invention. Various embodiments of the invention reflect an appreciation that work queues for operating system (OS) runtime 454 services typically reside in an IHS's vulnerable main memory 324, such as one or more Dual Inline Memory Modules, which is accessible via standard OS services. In various embodiments, one or more trusted queue management (TQM) operations, described in greater detail herein, may be implemented to include a device-specific buffer handling operation 610, 612.

In various embodiments, one or more device-specific buffer handling operations 610, 612 may be performed to provide a TQM firmware service. In certain of these embodiments, the TQM firmware service may be implemented during the Pre Extensible Firmware Interface (EFI) Initialization (PEI) 436 phase, described in greater detail herein, to allocate 608 a portion of a particular IHS's lower main memory 324 (e.g., 1 MB 326 to 1 GB 328), which is inaccessible to normal runtime services. In various embodiments, one or more protected queues 602, such as a protected work queue 606, or a protected event queue 604, or a combination of the two, may be established within the allocated region, linked to an event table, and device event handlers 528 during OS runtime 454. In various embodiments, the device event handlers 528 may be implemented to interact with certain associated device control registers 640.

In various embodiments, the protected work queue 606, and the protected event queue 604, or a combination of the two may be created and used whenever a new OS runtime 454 request is received and the request is authenticated. In various embodiments, one or more device-specific buffer handling operations 612 may be performed to authenticate the OS runtime 454 request as an authenticated event 614. Various embodiments of the invention reflect an appreciation that such an approach may assist in safeguarding against various memory attacks, including buffer overflows, as the lower main memory allocations are not enumerated during OS runtime 454.

In various embodiments, one or more runtime interfaces 620 may be implemented to interact with certain services, such as Windows Management Instrumentation (WMI) 616 and others 618. In various embodiments, the runtime interfaces 620 may in turn be implemented to interact with one or more trusted ports 622. In various embodiments, one or more TQM operation may be performed to enumerate the trusted ports 622 during OS runtime 454 communication for all device-specific communications through the use of a secure, zero trust runtime secure enclave (ZTRSE) 636. In various embodiments, an embedded controller (EC) 210 may be implemented to act as a gatekeeper to either authorize or deny a System Memory Interconnect (SMI) 624 call when an SMI 624 is triggered.

In various embodiments, protected queues 602, such as protected work queues 606, or protected event queues 604, or a combination of the two, may be established such that they can be managed by a particular data center asset's System Management Basic Input/Output System (SMBIOS) 512, and interact with certain peripheral devices, or components thereof. Examples of such peripheral devices, or components thereof, may include an embedded controller (EC) 638, non-volatile (NV) storage 542, one or more Serial Peripheral Interface (SPI) memory variables 544, or a fan control system 546, or a combination thereof. Other examples of such peripheral devices, or components thereof, may include a battery control system 548, an integrated system hub (ISH) 550, a storage control system 552 or a Redundant Array of Independent Disks (RAID)/Advanced Host Controller Interface (ACHI) 554, or a combination thereof.

In various embodiments, an Advanced Configuration and Power Interface (ACPI) Source Language (ASL) node, not shown, may be implemented to translate such interactions into device-specific methods linked to secure, trusted ports 622. In certain of these embodiments, such trusted ports 622, which are designed for communication queue enclaves, may be implemented to process trusted transaction requests that are secured following verification by an EC 210. In various embodiments, an EC 210 may be implemented to serve as a Root of Trust (ROT) 638, with SMBIOS 512 acting as the primary security manager, to ensure SMIs are routed exclusively through trusted ports 622.

In various embodiments, such trusted ports 622 may be recognized and listed by the OS during runtime 454, but may not be accessible for SMI 624 by default. In various embodiments, any incoming SMI may be initially blocked and verified for authenticity using a ZTRSE 636. In certain of these embodiments, the SMI 624 may be implemented to reinitiate communication through a secure trusted port 622 by issuing a virtual SMI 624 if the requestor is genuine. In various embodiments, the foregoing process may facilitate ensuring that data buffer processing occurs solely by trusted ports 622 endorsed by both the EC 210 and SMBIOS 512.

In various embodiments, if a vulnerable SMI 624 attempts to access the IHS, it will be unable to penetrate protected queues 626 ‘1’ 628, ‘2’ 630, ‘3’ 632 through ‘n’ 634. Furthermore, device-specific methods (DSMs), which could potentially reveal the address space of the IHS's low main memory, are now safeguarded by the ZTRSE 636. In various embodiments, implementation of the ZTRSE 636, in combination with the performance on one or more TQM operations, may facilitate ensuring that data pointers are barred from entering this protected portion of the IHS's low main memory 324, thereby assisting in maintaining security integrity.

Accordingly, one or more TQM operations may be implemented in various embodiments to use a zero-trust approach to authenticate and authorize certain runtime service requests from the OS at runtime 454. In various embodiments, the ZTRSE 636 may be initially implemented to intercept all service requests, which in turn may initiate a process where an ROT 638, described in greater detail herein, generates a key pair familiar to skilled practitioners of the art. In certain of these embodiments, the public key may be attached to the service request, while the private key is securely retained by the ROT 638.

In various embodiments, one or more event handlers 528 may be implemented to submit a Certificate Signing Request (CSR) for certain service requests that includes the previously-generated public key. In certain of these embodiments, the ROT 638 may be implemented to verify and attest each such service request, and then issue a signed digital certificate, also known as a secure event identifier (ID), back to the event handler 528. In various embodiments, a secure event ID may be implemented to enable the protocol to validate the request, which in turn may result in the creation of protected work queues 606, or event queues 604, or both, in a designated region in an associated IHS's lower main memory 324. In certain of these embodiments, each work queue 606, or event queue 604, may in turn be respectively implemented to trigger a corresponding event handler 528 that presents the secure event ID for verification and authorization by the ROT 638.

In various embodiments, a service request may be allowed to gain access to its associated IHS resources upon successful authorization, which may facilitate ensuring that only verified and permitted actions can interact with the IHS, thereby enhancing overall security. In various embodiments, a zero-trust approach may be implemented to facilitate ensuring all OS runtime 454 requests and event handlers 528 are authenticated and authorized to block unauthorized access and prevent OS service exploitation. In various embodiments, one or more TQM operations may be performed for device-specific buffer handling 610, 612 to assist in safeguarding against security vulnerabilities such as buffer overflows and other forms of memory exploitation attacks.

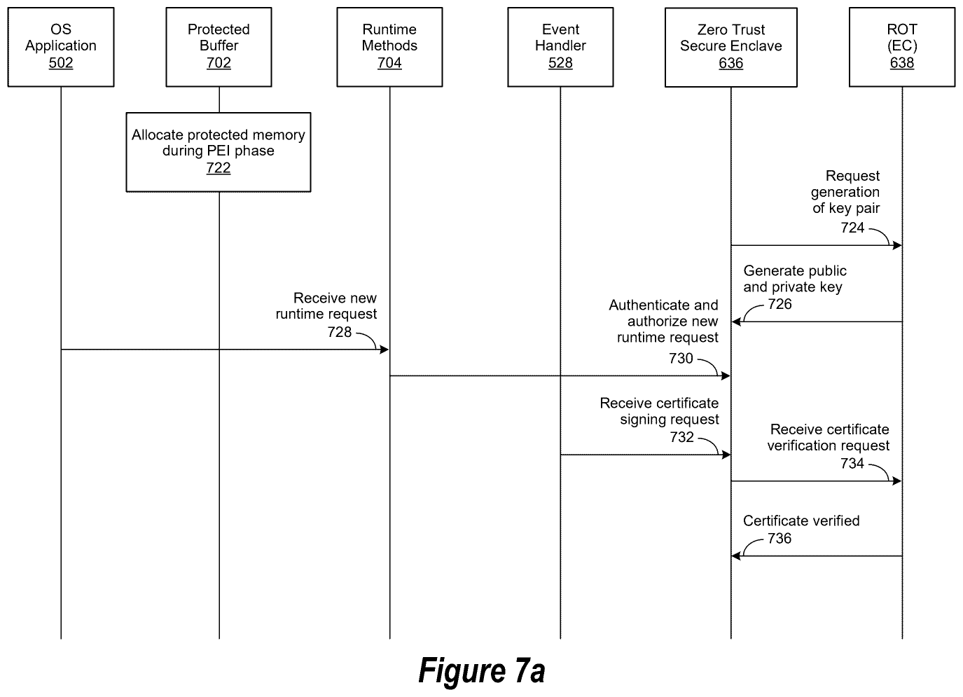

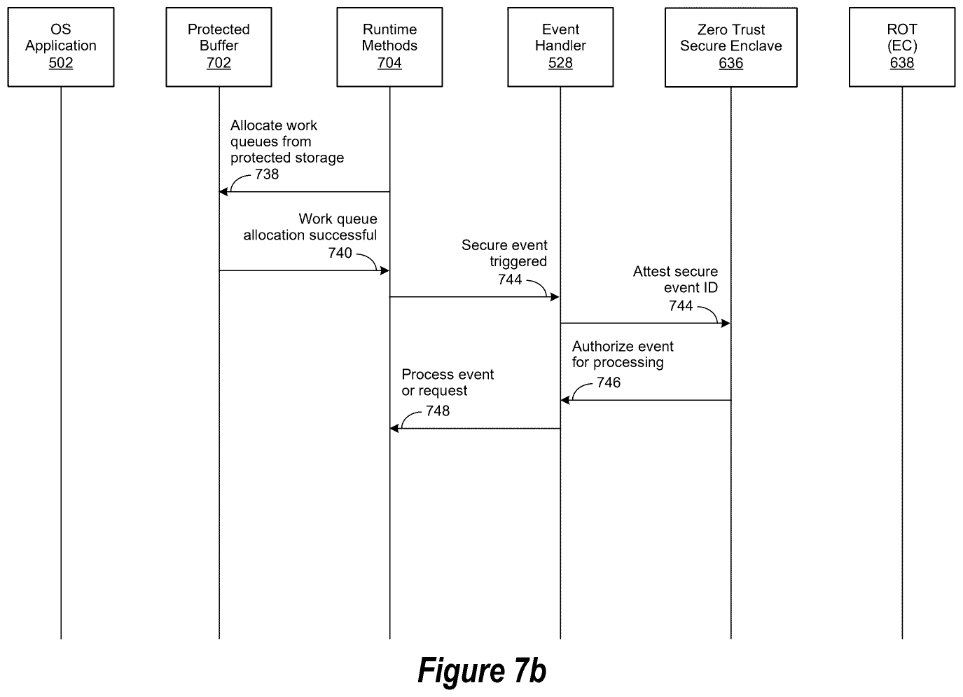

FIGS. 7a and 7b are a simplified sequence diagram showing the performance of certain trusted queue management (TQM) operations implemented in accordance with an embodiment of the invention. In this embodiment, protected memory is allocated, as described in greater detail herein, within a protected buffer 702 area of an IHS's low main memory in step 722. Then, in step 724, a zero-trust runtime secure enclave (ZTRSE) 636 places a request to a root of trust (ROT) 638 to generate a public/private key pair familiar to skilled practitioners of the art. In response, the ROT 638 generates the requested public/private key pair and provides it to the ZTRSE 636 in step 726.

Thereafter, a runtime method 704 then receives a new runtime request from a particular operating system (OS) application 502 in step 728. In response, the runtime method 704 submits a request to the ZTRSE 636 to authenticate and authorize the request in step 730, which it then provides to the ROT 638 in step 734. In response, the ZTRSE 636 verifies the validity of the certificate to the ZTRSE 636 in step 736.

Then, in step 738, the runtime method 704 allocates work queues, or event queues, or both, within the protected buffer 702 area of an IHS's low main memory. In response, the runtime method 704 receives notification that the event queues were successfully allocated with the protected buffer area 702 in step 740. Thereafter, the runtime method 704 triggers an event with the event handler 528 in step 742.

In turn, the event handler 528 attests to the validity of the request's secure ID, described in greater detail herein, to the ZTRSE 636 in step 744. In response, the ZTRSE 636 provides authorization in step 746 to the event handler 528 to process the event. Thereafter, the event handler 526 authorizes the runtime method 704 to process the event in step 748.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed BIOS;
identifying device specific data associated with a device of the information handling system;
enumerating a trusted port via a trusted queue management operation; and,
authorizing device specific communication via the trusted port, the device specific communication using a device-specific buffer handling operation.

2. The method of claim 1, wherein:
the information handling system includes an embedded controller, the embedded controller being implemented to enable a BIOS root of trust.

3. The method of claim 2, wherein:
the trusted port is generated via a secure enclave protocol; and,
the secure enclave protocol uses the BIOS root of trust when generating the trusted port.

4. The method of claim 3, wherein:
a device specific buffer handling protocol is used to generate a dedicated protected queue, the dedicated protected queue being associated with the device specific data of the device of the information handling system.

5. The method of claim 1, wherein:
runtime device-specific communications use a secure, zero trust runtime secure enclave.

6. The method of claim 5, wherein:
the secure, zero trust runtime secure enclave protects a low memory portion of memory of the information handling system.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS;
identifying device specific data associated with a device of the information handling system;
enumerating a trusted port via a trusted queue management operation; and,
authorizing device specific communication via the trusted port, the device specific communication using a device-specific buffer handling operation.

8. The system of claim 7, wherein:
the information handling system includes an embedded controller, the embedded controller being implemented to enable a BIOS root of trust.

9. The system of claim 7, wherein:
the trusted port is generated via a secure enclave protocol; and,
the secure enclave protocol uses the BIOS root of trust when generating the trusted port.

10. The system of claim 9, wherein:
a device specific buffer handling protocol is used to generate a dedicated protected queue, the dedicated protected queue being associated with the device specific data of the device of the information handling system.

11. The system of claim 7, wherein:
runtime device-specific communications use a secure, zero trust runtime secure enclave.

12. The system of claim 11, wherein:
the secure, zero trust runtime secure enclave protects a low memory portion of memory of the information handling system.

13. A non-transitory, computer-readable storage medium embodying computer program code, the computer program code comprising computer executable instructions configured for:
providing an information handling system with a distributed BIOS;
identifying device specific data associated with a device of the information handling system;
enumerating a trusted port via a trusted queue management operation; and,
authorizing device specific communication via the trusted port, the device specific communication using a device-specific buffer handling operation.

14. The non-transitory, computer-readable storage medium of claim 13, wherein:
the information handling system includes an embedded controller, the embedded controller being implemented to enable a BIOS root of trust.

15. The non-transitory, computer-readable storage medium of claim 14, wherein:
the trusted port is generated via a secure enclave protocol; and,
the secure enclave protocol uses the BIOS root of trust when generating the trusted port.

16. The non-transitory, computer-readable storage medium of claim 15, wherein:
a device specific buffer handling protocol is used to generate a dedicated protected queue, the dedicated protected queue being associated with the device specific data of the device of the information handling system.

17. The non-transitory, computer-readable storage medium of claim 13, wherein:
runtime device-specific communications use a secure, zero trust runtime secure enclave.

18. The non-transitory, computer-readable storage medium of claim 17, wherein:
the secure, zero trust runtime secure enclave protects a low memory portion of memory of the information handling system.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
